(19) United States
(12) Patent Application Publication
(10) Pub. No.: US 2006/0143240 A1
(43) Pub. Date: Jun. 29, 2006

(54) Method and system for backing up to and restoring from external media

(75) Inventors: Rick Sun, Chongqing (CN); Lisa Lei, Chongqing (CN)

Correspondence Address: ARENT FOX PLLC, 1050 CONNECTICUT AVENUE, N.W., SUITE 400, WASHINGTON, DC, 20036, US

(73) Assignee: FarStone Tech, Inc.

(21) Appl. No.: 11/297,648

(22) Filed: Dec. 9, 2005

(30) Foreign Application Priority Data
Dec. 10, 2004 (TW) 93138506

(51) Int. Cl. G06F 17/30

(52) U.S. Cl. 707/202

(57) ABSTRACT

A backup/recovery system is provided which has ability to back up and restore every type of recovery point to external storage media. A backup method is also provided, suitable for a computer system including a hard disk and at least one recovery point stored therein, the recovery points holding data being changed within said hard disk, The backup method includes selecting a predetermined recovery point, writing data contained in a base recovery point into a external storage media, said base recovery point corresponding to a status of said hard disk, and writing data contained in said predetermined recovery point into said external storage media.

### CROSS-REFERENCE TO RELATED APPLICATIONS

The present application claims priority, under 35 U.S.C. § 119, to foreign application no. 93138506 filed Dec. 10, 2004 in Taiwan, the contents thereof are incorporated by reference herein by the entirety.

### BACKGROUND OF THE INVENTION

1. Field of Invention

The present invention relates to a backup/recovery technique for a computer system. More particularly, the present invention relates to a backup/recovery system, backs up to and restores from storage media for protecting the computer system conveniently.

2. Description of Related Art

The protection for the computer system generally utilizes a backup/recovery software for storing data and system configurations and/or recovering from a system crash. For example, the conventional backup/recovery software, such as the Ghost software developed by Symantec Corporation, includes a static backup program to back up all data stored in the partitions that are selected to be backed up.

Referring to FIG. 1, a schematic diagram shows the conventional backup/recovery software backing up data. The Ghost software backs up all the data stored in an entire hard drive or an individual partition, As shown in FIG. 1, it backs up data 11 stored in the hard disk 10 to an image file 12 on external storage media 20, the data itself backed up by the Ghost software occupies an extremely large space. The image files 12 are independent and self-contained, so as to respectively provide the ability to completely restore all backed-up files.

It can dump image files to external storage media, such as backing up data to CD-R/RW drives because the image files are large. To save the storage space in the external storage media, the image files are limited. The conventional backup/recovery software, although having the external backup/recovery function, contains merely a current state of the data corresponded to each image file.

In spite of the incremental backup technique is available on the market, it is impractical to adopt such technique. As such, restoring the computer system needs all files that have been changed. Every change to the data has to be backed up by the incremental backup technique accordingly. For example, if you created a full backed-up file on Friday and incrementals on Monday, Tuesday and Wednesday, and the PC crashes Thursday morning, you would need all four backups: Friday's full backed-up file plus the incremental backed-up files for Monday, Tuesday and Wednesday. However, it would be unfeasible to attempt to keep every backed-up files in storage-limited media.

In light of the foregoing, there is a need in the art to provide a backup/recovery software with ability to backup/restore a variety of working states of the computer system to/from external storage media.

### BRIEF SUMMARY OF THE INVENTION

Accordingly, the present invention provides a backup/recovery system that can back up and restore incremental recovery point to external storage media.

To achieve these and other advantages and in accordance with the purpose of the invention, as embodied and broadly described herein, the invention provides a method for backing up and/or recovering data.

An object of the present invention is to provide a backup/recovery system and method, wherein incremental recovery points can be kept in a external storage media. The off-site storage reserves hard drive space for other uses and protects from hard drive failure.

Another object of the present invention is to provide a backup/recovery system and method, which can store the backup images on a CD-RW/DVD-RW, a USB drive or the network. The incremental recovery points will be sent to the writable CD or DVD drive.

In accordance with one aspect of the present invention, a backup method is suitable for a computer system. The computer system includes a hard disk and at least one recovery point stored therein. The recovery points holds data being changed within the hard disk. The backup method comprises the steps of: selecting a predetermined recovery point; writing data contained in a base recovery point into a external storage media, the base recovery point corresponding to a status of the hard disk; and writing data contained in the predetermined recovery point into the external storage media.

In accordance with one aspect of the present invention, the backup method further comprises the step of creating a backup file in the external storage media, wherein data contained in the base recovery point and the predetermined recovery point are written into the backup file.

In accordance with one aspect of the present invention, the backup method further comprises the step of discarding the predetermined recovery point.

In accordance with another aspect of the present invention, a recovery method is suitable for a computer system coupled to a external storage media. The external storage media stores a base recovery point and at least one recovery point. The base recovery point corresponds to a status of a hard disk included in the computer system. The at least one recovery point holds data being changed within the hard disk. The recovery method comprises the steps of: selecting a predetermined recovery point among the at least one recovery point; writing data contained in a base recovery point into the hard disk; and writing data contained in the predetermined recovery point into the hard disk.

In accordance with another aspect of the present invention, the recovery method further comprises the step of writing data contained in intermediate recovery points between the base recovery point and the selected recovery point, into the hard disk.

In accordance with another aspect of the present invention, the recovery method further comprises the step of selecting a backup file, wherein the external storage media stores a plurality of backup files therein.

In accordance with a further aspect of the present invention, another backup method is suitable for a computer system. The computer system includes a hard disk and a plurality of recovery points stored therein. The recovery points holds data being changed within the hard disk. The backup method comprises the steps of: selecting at least one recovery point; determining a recovery point among the at least one recovery point in accordance with creating time of the at least one recovery point; writing data contained in a base recovery point into a external storage media, the base recovery point corresponding to a status of the hard disk; and writing data contained in the determined recovery point and a predetermined number of intermediate recovery points between the base recovery point and the determined recovery point, into the external storage media.

In the preferred embodiment of the invention, the backup method further comprises the step of creating a backup file in the external storage media, wherein data contained in the base recovery point, the determined recovery point and the predetermined number of intermediate recovery points are written into the backup file.

The backup method further comprises the step of discarding the determined recovery point and the predetermined number of intermediate recovery points.

In accordance with a still further aspect of the present invention, yet another backup method is suitable for a computer system. The computer system includes a hard disk and a first predetermined number of recovery points stored therein. The first predetermined number of recovery points holds data being changed within the hard disk. The backup method comprises the steps of: selecting at least one recovery point among the first predetermined number of recovery points; determining a recovery point among the at least one recovery point in accordance with creating time of the at least one recovery point; and writing data contained in the determined recovery point and a second predetermined number of time-relevant recovery points among the first predetermined number of recovery points, into the external storage media.

In the preferred embodiment of the invention, the backup method further comprises the step of creating a backup file in the external storage media, wherein data contained in the determined recovery point and the second predetermined number of time-relevant recovery points are written into the backup file.

In the preferred embodiment of the invention, the backup method further comprises the step of discarding the written recovery points.

In the preferred embodiment of the invention, the first predetermined number of recovery points is at least one.

The determined recovery point is created at the earliest time among the at least one recovery point. The second predetermined number of time-relevant recovery points is not less than zero. The second predetermined number of time-relevant recovery points is every recovery point being created after the creation of the determined recovery point.

The determined recovery point is created at the latest time among the at least one recovery point. The second predetermined number of time-relevant recovery points is not less than zero. The second predetermined number of time-relevant recovery points is every recovery point being created before the creation of the determined recovery point.

It is to be understood that both the foregoing general description and the following detailed description are exemplary, and are intended to provide further explanation of the invention as claimed.

### DESCRIPTION OF THE DRAWINGS

The above-mentioned objects and other objects and features of this invention and manner of attaining them will become apparent, and the invention itself will be understood by reference to the following description of the preferred embodiments of the invention taken in conjunction with the accompanying drawings, which are given by way of illustration only, and thus are not limitative of the present invention, and wherein:

FIG. 1 (Prior Art) illustrates a schematic diagram of a conventional backup/recovery software;

FIG. 2 illustrates a schematic diagram of a backup/recovery system as an embodiment of the invention;

FIG. 3 illustrates a schematic diagram of backup data as an embodiment of the invention.

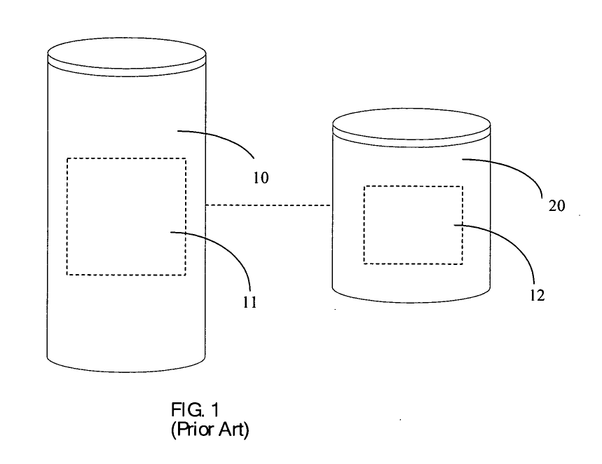

### DETAILED DESCRIPTION OF THE PREFERRED EMBODIMENT

Reference will now be made in detail to the present preferred embodiments of the invention, examples of which are illustrated in the accompanying drawings. Wherever possible, the same reference numbers are used in the drawings and the description to refer to the same or like parts.

The present invention contemplates a backup/recovery system to back up and restore incremental recovery points to external storage media. Therefore, the drawbacks faced by the prior arts can be solved completely.

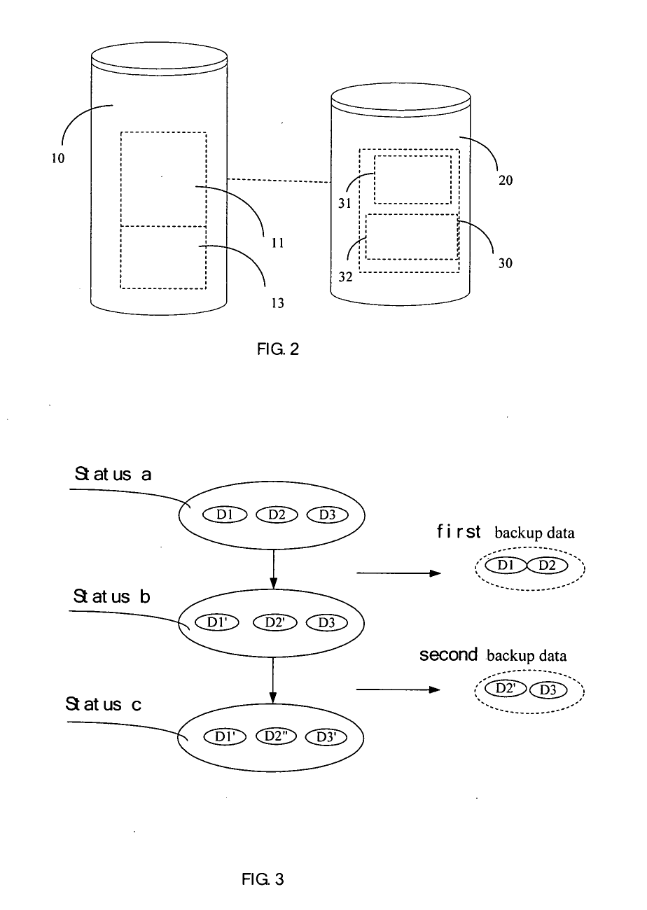

Referring to FIG. 2, a schematic diagram of a backup/recovery system of a preferred embodiment according to the present invention is shown. The backup/recovery system of the present invention is suitable for storing data and system configurations and/or recovering from a system crash. The backup/recovery system is installed in a computer system. The computer system includes a hard disk 10. The hard disk 10 stores and retrieves user data 11.

The backup/recovery system includes at least a static backup module and an incremental backup module. The static/incremental backup module creates static/incremental recovery points 13 on the hard disk 10. The static recovery point keeps all valid data of the user data 11, i.e., all valid data of the hard disk 10 needed to be protected. The incremental recovery point keeps valid data being changed within the hard disk 10.

The computer system is coupled to an external storage media 20. The external storage media 20 can be a CD-RW/DVD-RW, a USB or a network drive. The external storage media 20 creates a backup file 30. The backup file 30 contains incremental recovery points 31 and dependent data 32. The dependent data 32 will be described in detail as follows.

Referring to FIG. 3, a schematic diagram of backup data as an embodiment of the invention is shown. In disk status a, data D1, D2 and D3 are stored in the hard disk 10. While in disk status b, data D1′, D2′ and D3 are stored therein. In disk status c, data D1′, D2″ and D3′ are stored thereafter. Each status represents the state of the hard disk 10 of the computer system.

Data D1 and D2 are changed from the disk status a to the disk status b. Data D2′ and D3 is changed from the disk status b to the disk status c. hence, the computer system creates at least a first recovery point and a second recovery point for storing backed up data, each of which is able to revert the computer system to the disk status a and the disk status b.

For the sake of reverting the hard disk to the disk status a from the disk status b, a first backup data needs to be backed up. For reverting the hard disk to the disk status b from the disk status c, a second backup data needs to be backed up. The first backup data includes data D1 and D2, and the second backup data includes data D2′ and D3.

Data D1′ and D3 are incorporated with the recovery point to restore the computer system to a previous state, from a later state. As such, data D1′ is incorporated with the second recovery point to restore the computer system to the disk status b. Data D1′ will be kept in the external storage media, which are so-called dependent data 32.

As shown in FIG. 3, disk status c represents a current state of the hard disk 10 of the computer system. Data contained in disk status c is written into a external storage media 20, as a base recovery point. Thus, the dependent data 32 within the base recovery point is stored in an external storage media 20.

According to the preferred embodiment of the present invention, a backup method is suitable for a computer system. The computer system includes a hard disk and at least one recovery point stored therein. The recovery points holds data being changed within the hard disk. The backup method comprises the steps of: selecting a predetermined recovery point; writing data contained in a base recovery point into a external storage media, the base recovery point corresponding to a status of the hard disk; and writing data contained in the predetermined recovery point into the external storage media. Here is referred to the CD-RW/DVD-RW, it being understood that the invention is capable of use in various other combinations and environments and is capable of changes or modifications within the scope of the inventive concepts as expressed hereunder.

The backup method further comprises the step of creating a backup file in the external storage media, wherein data contained in the base recovery point and the predetermined recovery point are written into the backup file.

The backup method further comprises the step of discarding the predetermined recovery point.

According to the preferred embodiment of the present invention, another backup method is suitable for a computer system. The computer system includes a hard disk and a plurality of recovery points stored therein. The recovery points holds data being changed within the hard disk. The backup method comprises the steps of: selecting at least one recovery point; determining a recovery point among the at least one recovery point in accordance with creating time of the at least one recovery point; writing data contained in a base recovery point into a external storage media, the base recovery point corresponding to a status of the hard disk; and writing data contained in the determined recovery point and a predetermined number of intermediate recovery points between the base recovery point and the determined recovery point, into the external storage media.

The backup method further comprises the step of creating a backup file in the external storage media, wherein data contained in the base recovery point, the determined recovery point and the predetermined number of intermediate recovery points are written into the backup file.

The backup method further comprises the step of discarding the the determined recovery point and the predetermined number of intermediate recovery points.

According to the preferred embodiment of the present invention, yet another backup method is suitable for a computer system. The computer system includes a hard disk and a first predetermined number of recovery points stored therein. The first predetermined number of recovery points holds data being changed within the hard disk. The backup method comprises the steps of: selecting at least one recovery point among the first predetermined number of recovery points; determining a recovery point among the at least one recovery point in accordance with creating time of the at least one recovery point; and writing data contained in the determined recovery point and a second predetermined number of time-relevant recovery points among the first predetermined number of recovery points, into the external storage media.

The backup method further comprises the step of creating a backup file in the external storage media, wherein data contained in the determined recovery point and the second predetermined number of time-relevant recovery points is written into the backup file.

The backup method further comprises the step of discarding the written recovery points.

The first predetermined number of recovery points is at least one.

The determined recovery point is created at the earliest time among the at least one recovery point. The second predetermined number of time-relevant recovery points is not less than zero. The second predetermined number of time-relevant recovery points is every recovery point being created after the creation of the determined recovery point.

The determined recovery point is created at the latest time among the at least one recovery point. The second predetermined number of time-relevant recovery points is not less than zero. The second predetermined number of time-relevant recovery points is every recovery point being created before the creation of the determined recovery point.

According to the preferred embodiment of the present invention, the backup method includes at least a selecting step and a writing step. The backup method is suitable for a computer system. The computer system includes a hard disk 10 and at least one recovery point 13 stored therein. The recovery point 13 holds data being changed within the hard disk 10.

The backup method comprises the steps of: selecting a predetermined recovery point in the hard disk 10; creating a backup file 30 in a external storage media 20; writing data contained in a base recovery point into the backup file 30 in the external storage media 20, the base recovery point corresponding to a current status of the hard disk 10; writing data contained in the predetermined recovery point 31 into the backup file 30 in the external storage media 20; and discarding the predetermined recovery point in the hard disk 10.

The predetermined recovery point in the hard disk 10 is created exactly before changing the hard disk 10 to the current state. Since the base recovery point corresponds to a current status of the hard disk 10, data contained in the base recovery point is stored in the hard disk 10. The base recovery point may not be included in the recovery point 13.

If the user has a hard drive crash and there's no way to retrieve files from it, the user can restore it from the external storage media 20. By retrieving the backup file 30, the computer system may be restored to the current state. With the predetermined recovery point 31, the computer system can be back to a recent former state.

According to the preferred embodiment of the present invention, another backup method includes at least a selecting step, a determining step and a writing step. The backup method is suitable for a computer system. The computer system includes a hard disk 10 and a plurality of recovery points 13 stored therein. The recovery point 13 holds data being changed within the hard disk 10.

The backup method comprises the steps of: selecting at least one recovery point in the hard disk 10; creating a backup file 30 in a external storage media 20; determining a recovery point among the at least one recovery point in accordance with creating time of the at least one recovery point; writing data contained in a base recovery point into the backup file 30 in the external storage media 20, the base recovery point corresponding to a current status of the hard disk 10; writing data contained in the determined recovery point and intermediate recovery points between the base recovery point and the determined recovery point, into the backup file 30 in the external storage media 20; and discarding the determined recovery point and the intermediate recovery points in the hard disk 10.

The determined recovery point in the hard disk 10 is created at the earliest time among the at least one recovery point. Any intermediate recovery point between the base recovery point and the determined recovery point is written into the backup file 30 in the external storage media 20. Since the base recovery point corresponds to a current status of the hard disk 10, data contained in the base recovery point is stored in the hard disk 10. The base recovery point may not be included in the recovery point 13.

If the user has a hard drive crash and there's no way to retrieve files from it, the user can restore it from the external storage media 20. By retrieving the backup file 30, the computer system may be restored to the current state. With the determined recovery point and at least one intermediate recovery point 31, the computer system can be back to a previous state.

According to the preferred embodiment of the present invention, yet another backup method includes at least a selecting step, a determining step and a writing step. The backup method is suitable for a computer system. The computer system includes a protected hard disk 10 and at least one recovery point 13 stored therein. The recovery point 13 holds data being changed within the hard disk 10.

The backup method comprises the steps of: selecting at least one recovery point among the recovery point 13; determining a recovery point among the at least one recovery point in accordance with creating time of the at least one recovery point; creating a backup file 30 in the external storage media 20; writing data contained in the determined recovery point and a second predetermined number of time-relevant recovery points among the first predetermined number of recovery points, into the backup file 30 in the external storage media; and discarding the written recovery points.

The determined recovery point is created at the earliest time among the at least one recovery point. The second predetermined number of time-relevant recovery points is not less than zero. The second predetermined number of time-relevant recovery points is every recovery point being created after the creation of the determined recovery point.

Alternatively, the determined recovery point is created at the latest time among the at least one recovery point. The second predetermined number of time-relevant recovery points is not less than zero. The second predetermined number of time-relevant recovery points is every recovery point being created before the creation of the determined recovery point.

Since the hard drive is under protection, the user can restore the computer system back to any previous state, from a current status of the hard disk 10, by retrieving the determined recovery point with time-relevant recovery points in the external storage media 20, if any. If there is no time-relevant recovery points existed, the user may restore it to the recent former state, by merely retrieving the determined recovery point.

Accordingly, the user can not revert the computer system back to a few working states by a backup file in the external storage media. While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A backup method, suitable for a computer system including a hard disk and at least one recovery point stored therein, said recovery points holding data being changed within said hard disk, said backup method comprising the steps of:
selecting a predetermined recovery point;
writing data contained in a base recovery point into a external storage media, said base recovery point corresponding to a status of said hard disk; and
writing data contained in said predetermined recovery point into said external storage media.

2. The backup method according to claim 1, further comprising the step of creating a backup file in said external storage media, wherein data contained in said base recovery point and said predetermined recovery point are written into said backup file.

3. The backup method according to claim 1, further comprising the step of discarding said predetermined recovery point.

4. A backup method, suitable for a computer system including a hard disk and a plurality of recovery points stored therein, said recovery points holding data being changed within said hard disk, said backup method comprising the steps of:
selecting at least one recovery point;
determining a recovery point among said at least one recovery point in accordance with creating time of said at least one recovery point;
writing data contained in a base recovery point into a external storage media, said base recovery point corresponding to a status of said hard disk; and
writing data contained in said determined recovery point and a predetermined number of intermediate recovery points between said base recovery point and said determined recovery point, into said external storage media.

5. The backup method according to claim 4, further comprising the step of creating a backup file in said external storage media, wherein data contained in said base recovery point, said determined recovery point and said predetermined number of intermediate recovery points are written into said backup file.

6. The backup method according to claim 4, further comprising the step of discarding said discarding said determined recovery point and said predetermined number of intermediate recovery points.

7. A backup method, suitable for a computer system including a hard disk and a first predetermined number of recovery points stored therein, said first predetermined number of recovery points holding data being changed within said hard disk, said backup method comprising the steps of:
selecting at least one recovery point among said first predetermined number of recovery points;
determining a recovery point among said at least one recovery point in accordance with creating time of said at least one recovery point; and
writing data contained in said determined recovery point and a second predetermined number of time-relevant recovery points among said first predetermined number of recovery points, into said external storage media.

8. The backup method according to claim 7, further comprising the step of creating a backup file in said external storage media, wherein data contained in said determined recovery point and said second predetermined number of time-relevant recovery points are written into said backup file.

9. The backup method according to claim 7, further comprising the step of discarding said written recovery points.

10. The backup method according to claim 7, wherein said first predetermined number of recovery points is at least one.

11. The backup method according to claim 7, wherein said determined recovery point is created at the earliest time among said at least one recovery point.

12. The backup method according to claim 11, wherein said second predetermined number of time-relevant recovery points is not less than zero.

13. The backup method according to claim 12, wherein said second predetermined number of time-relevant recovery points are every recovery point being created after the creation of said determined recovery point.

14. The backup method according to claim 7, wherein said determined recovery point is created at the latest time among said at least one recovery point.

15. The backup method according to claim 14, wherein said second predetermined number of time-relevant recovery points is not less than zero.

16. The backup method according to claim 15, wherein said second predetermined number of time-relevant recovery points are every recovery point being created before the creation of said determined recovery point.
